(19) United States
(12) Patent Application Publication
(10) Pub. No.: US 2020/0053263 A1
(43) Pub. Date: Feb. 13, 2020

(54) DRIVE RECORDER

(71) Applicant: CAR MATE MFG. CO., LTD., Tokyo (JP)

(72) Inventors: Toshiyuki SUENAGA, Tokyo (JP); Kouji SHINADA, Tokyo (JP); Katsura IWAMOTO, Tokyo (JP); Yukiya MAEDA, Osaka-shi (JP)

(73) Assignee: CAR MATE MFG. CO., LTD., Tokyo (JP)

(21) Appl. No.: 16/344,782

(22) PCT Filed: Nov. 10, 2017
(86) PCT No.: PCT/JP2017/040577

§ 371 Date: Apr. 24, 2019

(30) Foreign Application Priority Data
Nov. 10, 2016 (JP) 2016-219458

(51) Int. Cl. H04N 5/225; H04N 5/232

(52) U.S. Cl. CPC H04N 5/22521; H04N 5/23218

(57) ABSTRACT

A drive recorder device with which components having low heat resistance can be protected and an image recording function can be sustained at a high pixel count or a high frame rate. The drive recorder device having an image sensor that images the surroundings and/or interior of a vehicle, the drive recorder device including: a temperature sensor that can measure the internal temperature of the drive recorder device; and a control unit that controls the image quality of the image sensor on the basis of a measurement value from the temperature sensor.

### TECHNICAL FIELD

The present invention relates to a drive recorder device that records the operating condition or parking condition of a vehicle.

### BACKGROUND ART

A drive recorder that records the operating condition or parking condition of a vehicle is used for the purposes of accident analysis, technical conformation of safe operation, crime prevention, and the like.

As such a conventional drive recorder, PTL1 discloses a technology for automatically changing the frame rate of image data to be recorded in an external recording device to a frame rate calculated by a recording method determination unit.

As another conventional technology, PTL2 discloses a technology in which a temperature detection unit that detects the internal temperature of a casing of a navigation device is disposed and a power source supply to a data reading unit is controlled on the basis of the temperature detected by the temperature detection unit, and thereby the operation of the data reading unit, which generates a large amount of heat during operation, is restricted in a stepwise manner on the basis of the temperature.

### CITATION LIST

### Patent Literature

PTL 1: JP2012-70217A

PTL 2: JP4507430B2

### SUMMARY OF INVENTION

### Technical Problem

However, according to the device of PTL1, there was a risk of damage to components with low heat resistance within the drive recorder device due to the increase in temperature within the drive recorder device, especially during the summer when the temperature within the vehicle becomes high. Alternatively, if a known temperature fuse or the like was installed, there was a risk that the temperature fuse would activate upon reaching a predetermined temperature, leading to a malfunction in which image data stops being recorded. In order to handle these temperature problems, an image sensor for on-vehicle installation which has superior heat resistance was utilized as the drive recorder in PTL1. However, such an image sensor for on-vehicle installation has a low pixel number compared to a general image sensor for a digital camera. Therefore, there are few drive recorders having a recording pixel number exceeding 2,000,000 pixels (which corresponds to full HD).

Further, according to the device of PTL2, the stepwise control by the data reading unit is merely control for limiting the power source supply according to a measured temperature. If such control was performed in a drive recorder, the image recording would become intermittent, and thus the original function of the drive recorder could not be achieved.

In consideration of the above-described problems in the prior art, an object of the present invention is to provide a drive recorder device with which components having low heat resistance can be protected and an image recording function can be sustained at a high pixel count or a high frame rate.

### Solution to Problem

As a first means for solving the above-described problems, the present invention provides a drive recorder device having an image sensor that images the surroundings and/or interior of a vehicle, the drive recorder device characterized by including: a temperature sensor that can measure the internal temperature of the drive recorder device; and a control unit that controls the image quality of the image sensor on the basis of a measurement value from the temperature sensor. According to the first means described above, the image quality, more specifically the frame rate or recording pixel number, of the drive recorder device can be changed or image recording by the drive recorder can be stopped according to changes in the temperature within the vehicle, and thus malfunctions during high temperatures of components having low heat resistance which are used in the drive recorder device can be eliminated.

As a second means for solving the above-described problems, the present invention provides the drive recorder device of the first means, wherein the image sensor has an effective pixel number of at least 2,000,000 pixels and a maximum frame rate of at least 27.5 fps.

According to the second means, a high-pixel-count image sensor having an effective pixel number exceeding 2,000,000 pixels can be utilized by the control of the first means.

As a third means for solving the above-described problems, the present invention provides the drive recorder device of the first or second means, wherein the control unit performs control to lower a frame rate or a recording pixel number of the image sensor when a temperature measurement as measured over time by the temperature sensor has transitioned to a high temperature.

According to the third means, malfunctions during high temperatures of components having low heat resistance which are used in the drive recorder device can be eliminated, and image recording can be sustained at a high pixel count or a high frame rate according to a change in temperature.

As a fourth means for solving the above-described problems, the present invention provides the drive recorder device of any of the first to third means, wherein the control unit controls an image recording operation of the image sensor on the basis of a measurement value from an acceleration sensor that detects impacts to the vehicle after an OFF signal of an ACC switch of the vehicle has been detected.

According to the fourth means, the frame rate of image recording by the drive recorder device can be changed or image recording can be stopped according to a change in temperature within the vehicle, especially when parked, and malfunctions during high temperatures of components having low heat resistance which are used in the drive recorder device can be eliminated.

### Effects of Invention

According to the present invention, the frame rate or recording pixel number of image recording by the drive recorder device can be changed or image recording can be stopped according to a change in temperature within the vehicle, and malfunctions during high temperatures of components having low heat resistance which are used in the drive recorder device can be eliminated.

### BRIEF DESCRIPTION OF DRAWINGS

FIG. 1 is a block diagram of a drive recorder device of the present invention.

FIG. 2 is block diagram of a parking mode device of the present invention.

FIG. 3 is a processing flow in a drive record mode of the drive recorder device of the present invention.

FIG. 4 is a processing flow when changing the image quality of an image sensor based on a temperature change.

FIG. 5 is a processing flow in a parking mode of the drive recorder device of the present invention.

### DESCRIPTION OF EMBODIMENTS

Embodiments of the drive recorder device of the present invention will now be explained in detail below referring to the attached drawings.

[Drive Recorder Device 10]

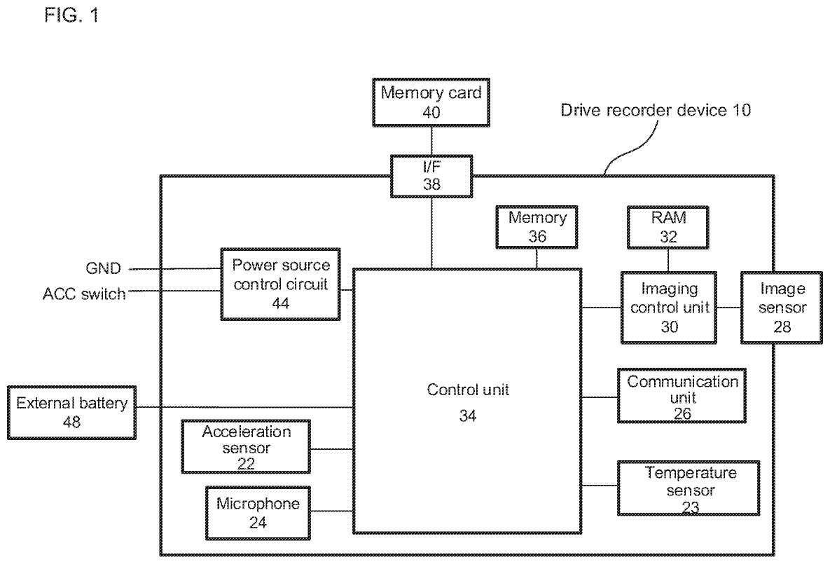

FIG. 1 is a block diagram of a drive recorder device 10 of the present invention. As illustrated therein, the drive recorder device 10 of the present invention includes the following: an acceleration sensor 22; a temperature sensor 23; a microphone 24; a communication unit 26; an image sensor 28; an imaging control unit 30; a RAM 32; a control unit 34; a memory 36; an I/F 38; a memory card 40; a power source control circuit 44; and an external battery 48.

The acceleration sensor 22 is an impact sensor that detects impacts which act on the vehicle, and is configured so as to be capable of transmitting a measurement value to the control unit 34 to be explained below. The acceleration sensor 22 of the present embodiment is used particularly in a parking mode.

The temperature sensor 23 is a sensor that detects the internal temperature of a drive recorder body, and is configured so as to be capable of transmitting a measurement value to the control unit 34 to be explained below.

The internal temperature of the drive recorder device of the present embodiment is, as an example, the temperature within the device casing, or the temperature of an image element of the image sensor 28.

The temperature sensor may be substituted with temperature sensors that are built into each sensor.

The microphone 24 records sounds of the vehicle, and is configured so as to be capable of transmitting recorded sound data to the control unit 34 to be explained below.

The communication unit 26 is configured so as to be capable of communicating with an external communication terminal (such as a smartphone, portable terminal, etc.) via wireless communication.

The image sensor 28 images the conditions on the inside and/or outside of the vehicle, and is configured so as to be capable of transmitting a video signal to the imaging control unit 30 to be explained later. The image sensor 28 of the present embodiment utilizes a sensor that has an effective pixel number of at least 2,000,000 pixels or more and a maximum frame rate of at least 27.5 fps or more, and that is capable of image recording at a high image quality of, for example, 8,000,000 pixels (corresponding to 4K) with a recording screen number of horizontal 2880×vertical 2880.

The imaging control unit 30 receives the video signal transmitted from the image sensor 28, performs prescribed image processing on the video signal, and then transmits the video signal to the control unit 34.

The RAM 32 cyclically records the image-processed video signal.

The control unit 34 executes a drive record mode or a parking device mode to be explained later when an ACC signal from an ACC (accessory) switch 12 has been detected.

The control unit 34 executes a parking mode to be explained later when no ACC signal from the ACC switch 12 is detected.

The memory 36 stores a determination threshold which is used for comparison with the measurement value of the temperature sensor 22.

The determination threshold of the temperature range in the present embodiment is set as described below.

Level 1 is a normal temperature range, and is, for example, a temperature range lower than 70 degrees, and the frame rate of Level 1 is set to 27.5 fps.

Level 2 is a temperature range that is slightly higher than Level 1, and is, for example, a range from 70 degrees to 80 degrees, and the frame rate of Level 2 is set to 13.75 fps.

Level 3 is a temperature range that is slightly higher than Level 2, and is, for example, a range from 80 degrees to 85 degrees, and the frame rate of Level 3 is 5.2 fps.

Level 4 is a temperature range of the limit of the components having low heat resistance, and is, for example, a range greater than 85 degrees, and image recording is to be stopped at Level 4.

The memory card 40 stores, via the I/F 38, a video signal or audio signal which needs to be recorded.

The power source control circuit 44 adjusts the power supplied from the ACC switch to a predetermined voltage.

The external battery 48 supplies external power to the drive recorder body 20.

[Parking Mode Device 50]

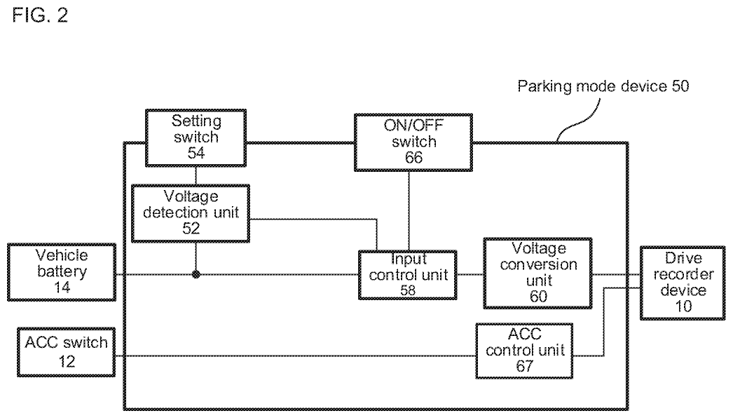

FIG. 2 is block diagram of a parking mode device of the present invention. A parking mode device 50 is connected between the ACC switch of the vehicle and the drive recorder body 20, and monitors the ON/OFF state of the ACC of the vehicle and notifies the state of the ACC switch to the drive recorder device 10.

The parking mode device 50 includes the following: a voltage detection unit 52; a setting switch 54; an input control unit 58; a voltage conversion unit 60; an ON/OFF switch 66; and an ACC control unit 67.

The voltage detection unit 52 detects a vehicle battery voltage supplied from a vehicle battery 14.

The setting switch 54 sets a predetermined threshold of the vehicle battery voltage.

The ON/OFF switch 66 is a manually operated switch that switches ON/OFF only the parking mode of the parking mode device 50 body.

The input control unit 58 controls the input of the vehicle battery voltage based on a signal from the ON/OFF switch 66.

The voltage conversion unit 60 converts the vehicle battery voltage to a predetermined voltage.

The vehicle battery 14 is a power source line for connecting the parking mode device 50 to a wire that is capable of supplying power from the vehicle battery.

The ACC switch 12 is a detection line for connecting to a wire that is capable of detecting the ACC of the vehicle.

The ACC control unit 67 is a control unit for notifying the state of the ACC switch 12 to the drive recorder device 10.

[Operation]

The operation of the drive recorder device of the present invention configured as described above will now be explained. The drive recorder device of the present invention can record in a drive record mode while the vehicle is being operated and in a parking mode while the vehicle is parked.

[Drive Record Mode]

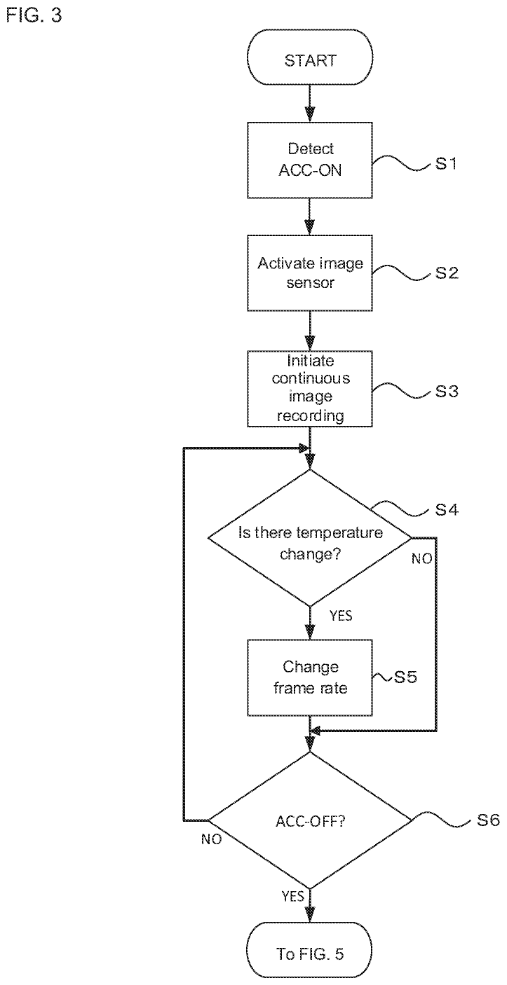

FIG. 3 is a processing flow in a drive record mode of the drive recorder device of the present invention.

The drive recorder device 10 is connected in advance to the ACC switch 12 of the vehicle and the vehicle battery 14. The vehicle battery voltage is supplied from the vehicle battery 14 to the drive recorder device 10. If it is detected that the ACC signal from the ACC switch 12 of the vehicle is ON (S1), the image sensor 28 is activated (S2). Continuous image recording by the image sensor 28 is then initiated (S3).

After it has been detected that the ACC signal is ON, the internal temperature of the drive recorder device 10 is also detected by the temperature sensor 23, and the following determination is made regarding a temperature change (S4).

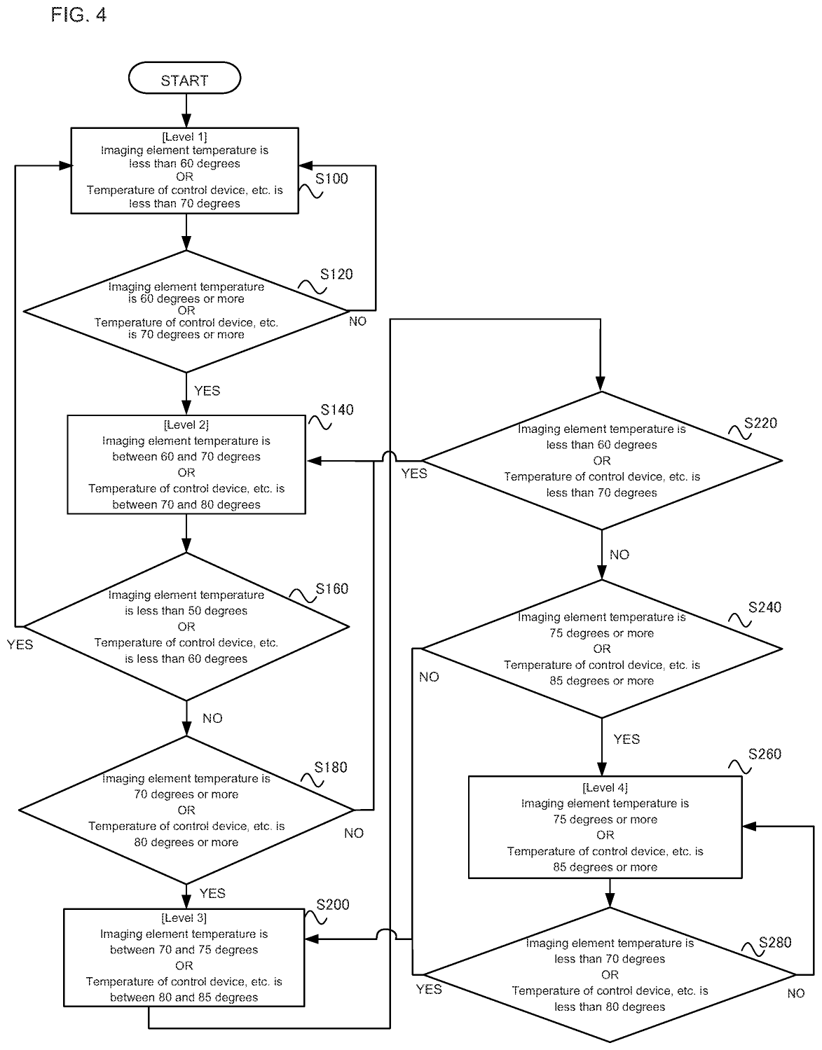

FIG. 4 is a processing flow when changing the image quality of the image sensor based on a temperature change.

If the temperature measured by the temperature sensor 23 is in the range of Level 1, i.e. if the image sensor temperature (also referred to as the imaging element temperature; same hereinafter) is less than 60 degrees or the temperature of the control device (drive recorder device 10), etc. is less than 70 degrees, a control signal for setting to the frame rate of Level 1 (normal recording, e.g. 27.5 fps) is output from the control unit 34 to the imaging control unit 30 (S100 (S5; the same applies to the subsequent Levels 2 to 4)).

If the temperature measured by the temperature sensor 23 is higher than Level 1, it is determined whether the image sensor temperature is 60 degrees or more or whether the temperature of the control device, etc. is 70 degrees or more (S120). If the measured temperature is lower than this temperature range (NO), the recording mode of Level 1 is implemented.

On the other hand, if the measured temperature is higher than this temperature range, and the image sensor temperature is between 60 and 70 degrees or the temperature of the control device, etc. is between 70 and 80 degrees, a control signal for setting to the frame rate of Level 2 (e.g. 13.75 fps) is output from the control unit 34 to the imaging control unit 30 (S140).

If the temperature drops during recording at Level 2, it is determined whether the image sensor temperature is less than 50 degrees or whether the temperature of the control device, etc. is less than 60 degrees (S160).

As a result, if the image sensor temperature is less than 50 degrees or the temperature of the control device, etc. is less than 60 degrees (YES), a control signal for setting to the frame rate of Level 1 is output from the control unit 34 to the imaging control unit 30.

On the other hand, if the temperature has not dropped, it is further determined whether the image sensor temperature is 70 degrees or more or whether the temperature of the control device, etc. is 80 degrees or more (S180).

If the measured temperature is lower than this temperature range (NO), the recording mode of Level 2 is implemented.

On the other hand, if the measured temperature is higher than this temperature range, and the image sensor temperature is between 70 and 75 degrees or the temperature of the control device, etc. is between 80 and 85 degrees, a control signal for setting to the frame rate of Level 3 (e.g. 5.2 fps) is output from the control unit 34 to the imaging control unit 30 (S200).

If the temperature drops during recording at Level 3, it is determined whether the image sensor temperature is less than 60 degrees or whether the temperature of the control device, etc. is less than 70 degrees (S220).

As a result, if the image sensor temperature is less than 60 degrees or the temperature of the control device, etc. is less than 70 degrees (YES), a control signal for setting to the frame rate of Level 2 is output from the control unit 34 to the imaging control unit 30.

On the other hand, if the temperature has not dropped, it is further determined whether the image sensor temperature is 75 degrees or more or whether the temperature of the control device, etc. is 85 degrees or more (S240).

If the measured temperature is lower than this temperature range (NO), the recording mode of Level 3 is implemented.

On the other hand, if the measured temperature is higher than this temperature range, and the image sensor temperature is 75 degrees or more or the temperature of the control device, etc. is 85 degrees or more, a control signal for setting to the frame rate of Level 4 (e.g. recording stop) is output from the control unit 34 to the imaging control unit 30 (S260).

If the temperature drops during the frame rate setting of Level 4, e.g. while recording is stopped, it is determined whether the image sensor temperature is less than 70 degrees or whether the temperature of the control device, etc. is less than 80 degrees (S280).

As a result, if the image sensor temperature is less than 70 degrees or the temperature of the control device, etc. is less than 80 degrees (YES), a control signal for setting to the frame rate of Level 3 is output from the control unit 34 to the imaging control unit 30.

On the other hand, if the temperature has not dropped (NO), the recording stop of Level 4 is continued.

The drive record mode is executed until it is detected that the ACC signal from the ACC switch 12 of the vehicle is OFF (S6). After it has been detected that the ACC signal is OFF (YES), the drive recorder device transitions to the parking mode described below.

[Parking Mode]

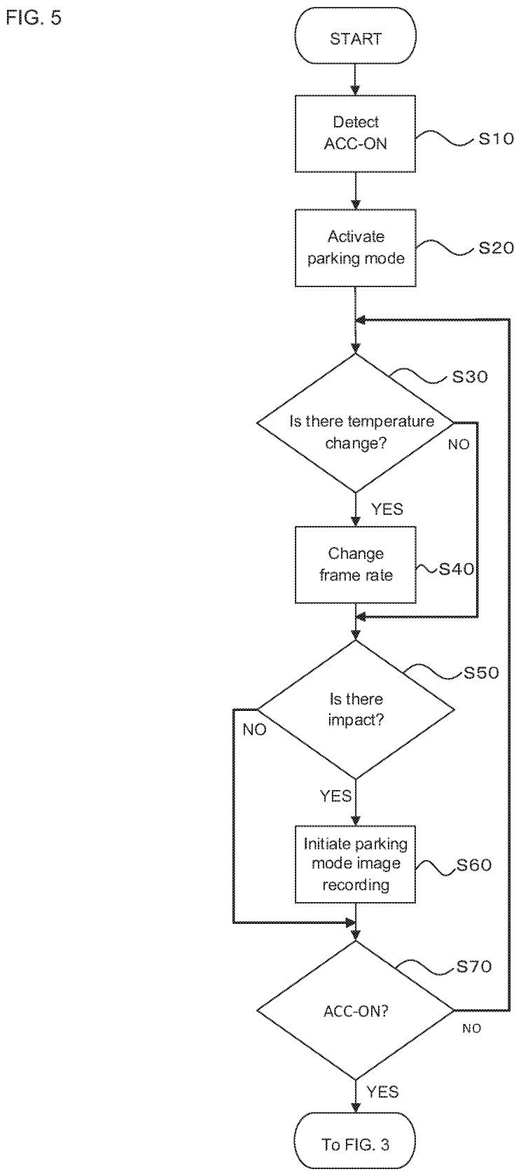

FIG. 5 is a processing flow in a parking mode of the drive recorder device of the present invention.

After it has been detected that the ACC signal is OFF (S10), the following parking mode is activated (S20). Unlike in the drive record mode in which recorded image data of a fixed duration is always retained as a buffer in the memory 36, in the parking mode of the present embodiment, a single recorded image data combining recorded image data (pre-impact) of the buffer of the memory 36 and recorded image data (post-impact) imaged after detection of an impact is recorded to the memory card 40 when a predetermined set value has been surpassed, such as when the acceleration sensor 22 detects vibration of an impact or the like.

After it has been detected that the ACC signal is OFF, the internal temperature of the drive recorder device 10 is also detected by the temperature sensor 23, and a determination regarding Levels 1 to 4 of the temperature change shown in FIG. 4 is made with regard to the temperature change (S30, S40).

At Levels 1 and 2, if an impact is detected by the acceleration sensor and the predetermined set value has been surpassed (S50), a single recorded image data combining the recorded image data (pre-impact) of the buffer of the memory 36 and the recorded image data (post-impact) imaged after detection of the impact is recorded to the memory card 40.

At Level 3, the recorded image data (post-impact) imaged after detection of the impact is recorded to the memory card 40 as the recorded image data.

At Level 4, recording is stopped (S60).

In the parking mode, recording is not performed during a period in which no impact is detected.

The parking mode is executed until it is detected that the ACC signal from the ACC switch 12 of the vehicle is ON (S70). After it has been detected that the ACC signal is ON (YES), the drive recorder device transitions to the above-described drive record mode.

In the control of the image quality in the above-described embodiment, the frame rate was changed. However, the image quality control is not limited to such an embodiment, and the image quality can also be controlled by changing the pixel number.

According to the present invention configured as described above, the frame rate of image recording or the recording pixel number of the drive recorder device can be changed or image recording by the drive recorder device can be stopped according to changes in the temperature within the vehicle, and thus malfunctions during high temperatures of components having low heat resistance which are used in the drive recorder device can be eliminated. Further, image recording can be sustained at a high pixel count or a high frame rate according to a change in temperature.

### INDUSTRIAL APPLICABILITY

The drive recorder of the present invention is industrially applicable in the field of vehicle-related manufacturing and the field of transportation.

### REFERENCE SIGNS LIST

10 . . . drive recorder device
12 . . . ACC switch
14 . . . vehicle battery
22 . . . acceleration sensor
23 . . . temperature sensor
24 . . . microphone
26 . . . communication unit
28 . . . image sensor
30 . . . imaging control unit
32 . . . RAM
34 . . . control unit
36 . . . memory
38 . . . I/F
40 . . . memory card
44 . . . power source control circuit
48 . . . external battery
50 . . . parking mode device
52 . . . voltage detection unit
54 . . . setting switch
58 . . . input control unit
60 . . . voltage conversion unit
66 . . . ON/OFF switch
67 . . . ACC control unit

1. A drive recorder device having an image sensor that images the surroundings and/or interior of a vehicle, the drive recorder device comprising:
a temperature sensor that can measure the internal temperature of the drive recorder device; and
a control unit that performs image recording control in a multi-step manner on the image quality of the image sensor or stops the image recording on the basis of a measurement value from the temperature sensor.

2. The drive recorder device according to claim 1, wherein the control unit controls the image quality in a stepwise manner to high image quality, medium image quality, and low image quality on the basis of a measurement value from the temperature sensor.

3. The drive recorder device according to claim 1, wherein the internal temperature of the drive recorder device is the temperature within a device casing and the temperature of an image element of the image sensor.

4. The drive recorder device according to claim 1, wherein the control unit performs control to record the image recording of the image sensor before impact detection and after impact detection, or performs control to record the image recording of the image sensor after impact detection, on the basis of measurement values from an acceleration sensor that detects impacts to the vehicle and from the temperature sensor after an OFF signal of an ACC switch of the vehicle has been detected.

5. The drive recorder device according to claim 2, wherein the internal temperature of the drive recorder device is the temperature within a device casing and the temperature of an image element of the image sensor.

6. The drive recorder device according to claim 2, wherein the control unit performs control to record the image recording of the image sensor before impact detection and after impact detection, or performs control to record the image recording of the image sensor after impact detection, on the basis of measurement values from an acceleration sensor that detects impacts to the vehicle and from the temperature sensor after an OFF signal of an ACC switch of the vehicle has been detected.

7. The drive recorder device according to claim 3, wherein the control unit performs control to record the image recording of the image sensor before impact detection and after impact detection, or performs control to record the image recording of the image sensor after impact detection, on the basis of measurement values from an acceleration sensor that detects impacts to the vehicle and from the temperature sensor after an OFF signal of an ACC switch of the vehicle has been detected.

8. The drive recorder device according to claim 5, wherein the control unit performs control to record the image recording of the image sensor before impact detection and after impact detection, or performs control to record the image recording of the image sensor after impact detection, on the basis of measurement values from an acceleration sensor that detects impacts to the vehicle and from the temperature sensor after an OFF signal of an ACC switch of the vehicle has been detected.
